(19) United States
(12) Patent Application Publication
(10) Pub. No.: US 2025/0329498 A1
(43) Pub. Date: Oct. 23, 2025

(54) ELECTRONIC COMPONENT

(71) Applicant: Murata Manufacturing Co., Ltd., Nagaokakyo-shi (JP)

(72) Inventors: Kazuki YOSHINO, Nagaokakyo-shi (JP); Hitoshi NISHIMURA, Nagaokakyo-shi (JP)

(21) Appl. No.: 19/257,715

(22) Filed: Jul. 2, 2025

Related U.S. Application Data
(63) Continuation of application No. PCT/JP2024/005008, filed on Feb. 14, 2024.

(30) Foreign Application Priority Data
Feb. 17, 2023 (JP) 2023-023504

(51) Int. Cl. H01G 4/232; H01G 4/30

(52) U.S. Cl. CPC H01G 4/2325; H01G 4/30

(57) ABSTRACT

A ceramic electronic component includes a main body portion and an outer electrode on a surface of the main body portion. The outer electrode includes a nickel plating layer including sulfur in a compound state and an atomic state. A ratio of an amount of sulfur included in the compound state to all sulfur included in the compound state and the atomic state in the nickel plating layer is about 25% or more and less than about 100%.

### CROSS REFERENCE TO RELATED APPLICATIONS

This application claims the benefit of priority to Japanese Patent Application No. 2023-023504 filed on Feb. 17, 2023 and is a Continuation Application of PCT Application No. PCT/JP2024/005008 filed on Feb. 14, 2024. The entire contents of each application are hereby incorporated herein by reference.

### BACKGROUND OF THE INVENTION

### 1. Field of the Invention

The present invention relates to electronic components.

### 2. Description of the Related Art

Japanese Unexamined Patent Application Publication No. 8-102425 discloses a method for forming a Ni (nickel) plating layer serving as an intermediate layer of an outer electrode of an electronic component by an electrolytic plating method. Japanese Unexamined Patent Application Publication No. 2021-19007 discloses an electronic component including a first Ni plating layer including a specific concentration of S (sulfur).

### SUMMARY OF THE INVENTION

When an electronic component including a Ni plating layer serving as a layer of an outer electrode is mounted on a circuit board and fixed by soldering, stress, such as thermal expansion and contraction stress and tensile stress, is generated in the Ni plating layer due to heat during soldering. As a result, a crack may occur in an end portion of an outer electrode peripheral portion of the electronic component.

When S is added to the Ni plating layer, internal stress is prevented from being generated during fixing by soldering, and a crack tends to be readily prevented from occurring. However, when S is added to the Ni plating layer, oxidation of the Ni layer is facilitated, and wettability deteriorates so that fixing by soldering may become insufficient so as to cause poor mounting. Therefore, it may be necessary to add a Ni plating layer having a relatively low S concentration on the Ni plating layer and to form a Sn (tin) plating layer thereon.

Example embodiments of the present invention provide ceramic electronic components in which oxidation and internal stress of a Ni plating layer are reduced or prevented.

A ceramic electronic component according to an example embodiment of the present invention includes a main body portion and an outer electrode on a surface of the main body portion. The outer electrode includes a nickel plating layer. The nickel plating layer includes sulfur in a compound state and an atomic state. A ratio of an amount of sulfur included in the compound state to all sulfur included in the compound state and the atomic state in the nickel plating layer is about 25% or more and less than about 100%.

According to example embodiments of the present invention, ceramic electronic components in which oxidation and internal stress of a nickel plating layer are reduced or prevented are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view illustrating an appearance of an electronic component according to a first example embodiment of the present invention.

FIG. 2 is a sectional view illustrating the electronic component in FIG. 1 when viewed from the direction of the arrow of line II-II.

FIG. 3 is a sectional view illustrating the electronic component in FIG. 1 when viewed from the direction of the arrow of line III-III.

FIG. 4 is a sectional view illustrating an electronic component according to a second example embodiment of the present invention.

### DETAILED DESCRIPTION OF THE EXAMPLE EMBODIMENTS

An electronic component according to each example embodiment of the present invention will be described below with reference to the drawings. In the explanations of each example embodiment below, the same or corresponding portions in the drawings are indicated by the same reference, and explanations thereof will not be repeated.

### First Example Embodiment

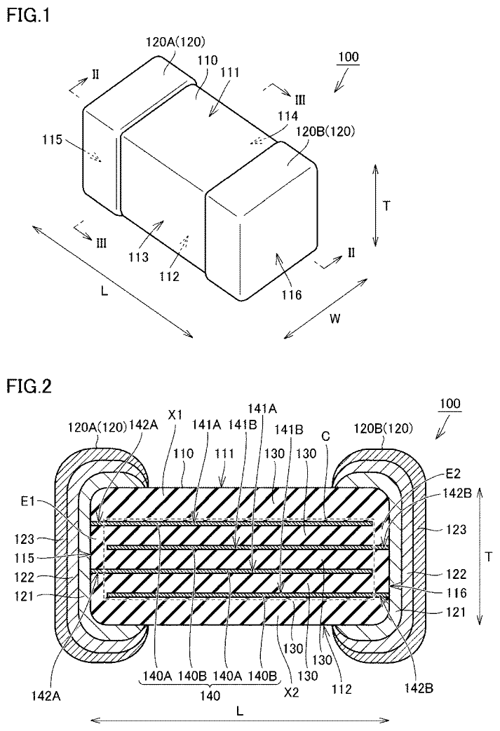

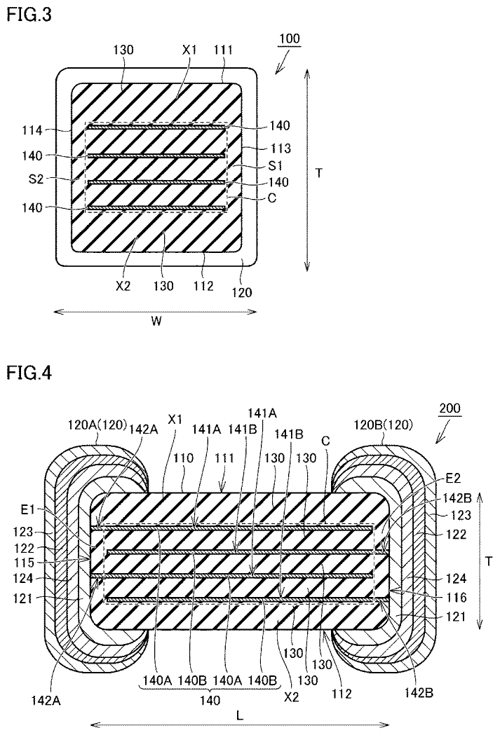

FIG. 1 is a perspective view illustrating an appearance of an electronic component according to a first example embodiment of the present invention. FIG. 2 is a sectional view illustrating the electronic component in FIG. 1 when viewed from the direction of the arrow of line II-II. FIG. 3 is a sectional view illustrating the electronic component in FIG. 1 when viewed from the direction of the arrow of line III-III.

As illustrated in FIG. 1, an electronic component 100 according to the first example embodiment of the present invention is a multilayer ceramic capacitor, and the electronic component 100 may be, for example, a multilayer thermistor, a multilayer inductor, or a ceramic battery (all-solid-state battery).

As illustrated in FIG. 1 to FIG. 3, the electronic component 100 according to the first example embodiment of the present invention includes a main body portion 110 and an outer electrode 120. In the present example embodiment, the main body portion 110 is a multilayer body and includes a plurality of dielectric layers 130 and a plurality of inner electrode layers 140 which are alternately stacked on a layer basis in the stacking direction T.

The main body portion 110 includes a first principal surface 111 and a second principal surface 112 which are opposite each other in the stacking direction T, a first side surface 113 and a second side surface 114 which are opposite each other in the width direction W orthogonal to the stacking direction T, and a first end surface 115 and a second end surface 116 which are opposite each other in the length direction L orthogonal to both the stacking direction T and the width direction W.

As illustrated in FIG. 1 and FIG. 2, the outer electrode 120 is disposed on the surface of the main body portion 110. In the electronic component 100 according to the present example embodiment, the outer electrode 120 includes a first outer electrode 120A and a second outer electrode 120B. The first outer electrode 120A is disposed on the first end surface 115. The second outer electrode 120B is disposed on the second end surface 116.

The plurality of inner electrode layers 140 include a plurality of first inner electrode layers 140A connected to the first outer electrode 120A and a plurality of second inner electrode layers 140B connected to the second outer electrode 120B. As illustrated in FIG. 2, the first inner electrode layer 140A includes an opposing portion 141A opposing the second inner electrode layer 140B and an extended portion 142A extended to the first end surface 115. In addition, the second inner electrode layer 140B includes an opposing portion 141B opposing the first inner electrode layer 140A and an extended portion 142B extended to the second end surface 116.

As illustrated in FIG. 1 to FIG. 3, the main body portion 110 that is a multilayer body is divided into an inner layer portion C, a first outer layer portion X1, a second outer layer portion X2, a first side margin portion S1, a second side margin portion S2, a first end margin portion E1, and a second end margin portion E2.

The inner layer portion C has an electrostatic capacitance due to the opposing portion 141A of the first inner electrode layer 140A and the opposing portion 141B of the second inner electrode layer 140B being stacked in the stacking direction T. The first outer layer portion X1 is located on the first principal surface 111 side of the inner layer portion C in the stacking direction T. The second outer layer portion X2 is located on the second principal surface 112 side of the inner layer portion C in the stacking direction T.

The first side margin portion S1 is located on the first side surface 113 side of the inner layer portion C in the width direction W. The second side margin portion S2 is located on the second side surface 114 side of the inner layer portion C in the width direction W. The first end margin portion E1 is located on the first end surface 115 side of the inner layer portion C in the length direction L. The second end margin portion E2 is located on the second end surface 116 side of the inner layer portion C in the length direction L.

From the viewpoint of size reduction of the electronic component 100, it is preferable that each of the dimension of the first side margin portion S1 in the width direction W, the dimension of the second side margin portion S2 in the width direction W, the dimension of the first end margin portion E1 in the length direction L, and the dimension of the second end margin portion E2 in the length direction L be decreased to such an extent that the insulation resistance of the electronic component 100 is not reduced. In the present example embodiment, as described later, since the insulation resistance of the electronic component 100 can be prevented from being reduced, each of the above-described dimensions can be relatively decreased. For example, each of the dimension of the first end margin portion E1 in the length direction L and the dimension of the second end margin portion E2 in the length direction L is preferably about 10 μm or more and about 30 μm or less.

The thickness of each of the plurality of dielectric layers 130 included in the inner layer portion C is preferably about 0.4 μm or more and about 0.8 μm or less and more preferably about 0.5 μm or more and about 0.7 μm or less, for example. In this regard, in the present specification, the thickness of each layer is a thickness of the end surface central portion.

Incidentally, in the present example embodiment, the electronic component 100 has a dimension in the length direction L of about 2.0 mm or less, a dimension in the width direction W of about 1.25 mm or less, and a dimension in the stacking direction T of about 1.25 mm or less, for example. The outline dimension of the electronic component 100 can be measured by observing the electronic component 100 by using an optical microscope.

The dielectric layer 130 includes a perovskite-type compound. Regarding the material of the dielectric layer 130, dielectric ceramics including BaTiO₃, CaTiO₃, SrTiO₃, or CaZrO₃ as a primary component can be used. In addition, a material in which a Mn compound, a Mg compound, a Si compound, an Fe compound, a Cr compound, a Co compound, a Ni compound, an Al compound, a V compound, a rare earth compound, or the like serving as a secondary component is added to the above-described primary component may be used. The relative permittivity of the material of the dielectric layer 130 is about 1,000 or more, for example.

The thickness of each of the plurality of inner electrode layers 140 is preferably about 0.3 μm or more and about 1.0 μm or less, for example. The coverage of the dielectric layer 130 being covered, with no gaps, by each of the plurality of inner electrode layers 140 is preferably about 50% or more and about 95% or less, for example.

The material of the inner electrode layer 140 includes one type of metal including Ni, Cu, Ag, PD, or Au, or an alloy including such a metal. For example, an alloy of Ag and Pd can be used. The inner electrode layer 140 may include a dielectric particle of the same composition system as the dielectric ceramics included in the dielectric layer 130.

As illustrated in FIG. 2, in the present example embodiment, the outer electrode 120 includes an underlying electrode layer 121, a Ni plating layer 122, and an upper plating layer 123 successively from the main body portion 110 side.

In the present example embodiment, the underlying electrode layer 121 is a baked layer produced by applying and baking a conductive paste onto the main body portion 110 that is a multilayer body. The underlying electrode layer 121 includes metal and glass. The above-described metal included in the underlying electrode layer 121 includes Cu (copper), Ag (silver), Au (gold), Ni (nickel), or Sn (tin), or an alloy including any one of these. The above-described glass includes, for example, Si.

The underlying electrode layer 121 may include a metal oxide, such as BaTiO₃.

The underlying electrode layer 121 may include a plurality of stacked layers. The underlying electrode layer 121 may be a layer fired simultaneously with the inner electrode layer 140.

The Ni plating layer 122 is disposed on the underlying electrode layer 121. The Ni plating layer 122 includes substantially only Ni metal. The Ni plating layer 122 includes a single layer. In this regard, the Ni plating layer 122 may include NiO (nickel oxide) as an incidental impurity due to a formation process of the Ni plating layer 122.

The Ni plating layer 122 includes S in a compound state and an atomic state, and a ratio of an amount of S included in the compound state to all S included in the compound state and the atomic state in the Ni plating layer 122 (hereafter also referred to as S compound ratio) is about 25% or more and less than about 100%. The present inventor discovered that compatibility between reduction or prevention of internal stress and reduction or prevention of oxidation of the Ni plating layer can be ensured by adjusting the concentration of S present in the atomic state in the Ni plating layer and adding a compound including S. Consequently, the strength of the ceramic electronic component is improved and the solder mountability is improved.

The weight concentration of S included in the atomic state relative to the total weight of Ni and S included in the Ni plating layer 122 (hereafter also referred to as S atomic concentration) is preferably about 3 ppm or more and about 163 ppm or less, for example, from the viewpoint of reduction or prevention of internal stress and oxidation. The reference of the S atomic concentration is the total weight of Ni and S included in the Ni plating layer 122.

The weight concentration of S included in the compound state relative to the total weight of Ni and S included in the Ni plating layer 122 (hereafter also referred to as S compound concentration) is preferably about 30 ppm or more and about 109 ppm or less, for example, from the viewpoint of reduction or prevention of internal stress and oxidation. The reference of the S compound concentration is the total weight of Ni and S included in the Ni plating layer 122.

S included in the compound state in the Ni plating layer 122 is present in a compound including S. Examples of the compound including S include Ni sulfamate or Ni sulfate.

The S compound ratio, the S atomic concentration, and the S compound concentration are measured in accordance with the method explained in the section of Examples described later.

A ratio of the amount of Ni present in a metal state (unoxidized state) in the surface of the Ni plating layer 122 to all Ni present in the surface of the Ni plating layer 122 (hereafter also referred to as Ni metal ratio) may be, for example, about 10% or more and, from the viewpoint of wettability, preferably about 15% or more, more preferably about 20% or more, and further preferably about 25% or more. The Ni metal ratio is measured in accordance with the method explained in the section of Examples described later. The surface of the Ni plating layer may be a region from the surface to some extent of depth and may be, for example, a region from the surface to a depth of about 5 nm or a region from the surface to a depth of about 10 nm.

The film stress of the Ni plating layer 122 is preferably about 50 MPa or less, more preferably about 40 MPa or less, and further preferably about 35 MPa or less, for example, from the viewpoint of reducing or preventing a crack from being formed in a ceramic element body. The film stress of the Ni plating layer 122 is measured in accordance with the method explained in the section of Examples described later.

In the present example embodiment, the average thickness of the Ni plating layer is preferably, for example, about 0.5 μm or more and about 10 μm or less, more preferably about 5.5 μm or less, and further preferably about 4.5 μm or less.

The upper plating layer 123 is disposed on the Ni plating layer 122 (opposite to the main body portion 110 side of the Ni plating layer 122). In the present example embodiment, the upper plating layer 123 includes Sn (tin). In the present example embodiment, the thickness of the upper plating layer 123 is preferably, for example, about 0.5 μm or more and about 10 μm or less and more preferably about 4.5 μm or less.

In the present example embodiment, regarding the layers of the outer electrode 120, the weight concentration of S relative to the weight of the respective layer increases in the order of the upper plating layer 123, the underlying electrode layer 121, and the Ni plating layer 122.

Next, a non-limiting example of a method for measuring the dimension of each configuration will be described.

The thickness of each of the dielectric layer 130 and the inner electrode layer 140 included in the inner layer portion C is measured as described below. Initially, the electronic component 100 is ground so as to expose a cross section orthogonal to the length direction L. The exposed cross section is observed by using a scanning electron microscope. Subsequently, the thickness of each of the dielectric layer 130 and the inner electrode layer 140 on five lines which are a total of the center line passing through the center of the exposed cross section in the stacking direction T and two lines drawn, at equal intervals, from the center line to each of both sides. An average value of five measurement values of the dielectric layer 130 is taken as the thickness of the dielectric layer 130. An average value of five measurement values of the inner electrode layer 140 is taken as the thickness of the inner electrode layer 140.

Alternatively, regarding each of an upper portion, a middle portion, and a lower portion located on border lines that divide the exposed cross section into four equal portions in the stacking direction T, the thickness of each of the dielectric layer 130 and the inner electrode layer 140 on the above-described five lines may be measured, an average value of measurement values of the dielectric layer 130 may be taken as the thickness of the dielectric layer 130, and an average value of measurement values of the inner electrode layer 140 may be taken as the thickness of the inner electrode layer 140.

Each of the dimension in the width direction W of the main body portion 110 that is a multilayer body and the dimension in the stacking direction T of the main body portion 110 is measured by observing a portion not covered with the first outer electrode 120A or the second outer electrode 120B in the main body portion 110 by using an optical microscope. The measurement position is set to be the central portion in the length direction L.

The dimension in the length direction L of the main body portion 110 that is a multilayer body is measured as described below. Initially, the electronic component 100 is ground so as to expose a cross section orthogonal to the width direction W. The exposed cross section is observed by using a microscope so as to measure the above-described dimension. The measurement position is set to be the central portion in the stacking direction T.

Each of the dimension in the stacking direction T of the first outer layer portion X1 and the dimension in the stacking direction T of the second outer layer portion X2 is measured as described below. Initially, the electronic component 100 is ground so as to expose a cross section orthogonal to the width direction W. The exposed cross section is observed by using a microscope so as to measure each of the above-described dimensions. The measurement position is set to be the central portion in the length direction L.

Each of the dimension in the length direction L of the first end margin portion E1 and the dimension in the length direction L of the second end margin portion E2 is measured as described below. Initially, the electronic component 100 is ground so as to expose a cross section orthogonal to the width direction W. The exposed cross section is observed by using a microscope so as to measure each of the above-described dimensions. The measurement position is set to be an upper portion, a middle portion, and a lower portion located on border lines that divide the exposed cross section into four equal portions in the stacking direction T. An average value of measurement values of the first end margin portion E1 at the three portions is taken as the dimension in the length direction L of the first end margin portion E1, and an average value of measurement values of the second end margin portion E2 at the three portions is taken as the dimension in the length direction L of the second end margin portion E2.

The thickness of each of the first side margin portion S1 and the second side margin portion S2 is measured as described below. Initially, the electronic component 100 is ground so as to expose a cross section orthogonal to the length direction L. The exposed cross section is observed by using a microscope so as to perform measurement. The measurement position is set to be an upper portion, a middle portion, and a lower portion located on border lines that divide the exposed cross section into four equal portions in the stacking direction T. An average value of measurement values of the first side margin portion S1 at the three portions is taken as the dimension in the width direction W of the first side margin portion S1, and an average value of measurement values of the second side margin portion S2 at the three portions is taken as the dimension in the length direction L of the second end margin portion E2.

The thickness of the underlying electrode layer 121 is measured as described below. Initially, the electronic component 100 is ground so as to expose a cross section orthogonal to the width direction W. The exposed cross section is observed by using a microscope so as to perform measurement. The measurement position is set to be the central portion in the stacking direction T.

In addition, the thickness of each of the Ni plating layer 122 and the upper plating layer 123 is measured as described below. Initially, the electronic component 100 is ground by using an FIB device so as to expose a cross section orthogonal to the width direction W. The exposed cross section is observed by using a microscope so as to measure each of the above-described thicknesses. The measurement position is set to be the central portion in the stacking direction T. In this regard, the thickness of the upper plating layer 123 may be measured by using an X-ray fluorescence film thickness gauge.

A non-limiting example of a method for manufacturing the electronic component 100 according to the first example embodiment of the present invention will be described below. In this regard, the method for manufacturing the electronic component 100 described below is a method for manufacturing a multilayer ceramic capacitor and is a method for mass-producing a plurality of multilayer ceramic capacitors simultaneously by performing processing all together up to a middle stage of the production process so as to produce a mother multilayer body, thereafter dividing the mother multilayer body into individual pieces, and subjecting unfired multilayer bodies after division into individual pieces to further processing.

When the electronic component 100 that is a multilayer ceramic capacitor is produced, initially, a ceramic slurry is prepared. Specifically, a ceramic powder, a binder, a solvent, and the like are mixed at a predetermined ratio so as to produce the ceramic slurry.

Thereafter, a ceramic green sheet is formed. Specifically, the ceramic slurry is molded into the shape of a sheet on a carrier film by using a die coater, a gravure coater, a microgravure coater, or the like so as to form the ceramic green sheet.

Subsequently, a mother sheet is formed. Specifically, a conductive paste is printed having a predetermined pattern on the ceramic green sheet by a screen printing method, a gravure printing method, or the like so as to form the mother sheet in which a predetermined conductive pattern is disposed on the ceramic green sheet.

Regarding the mother sheet, a ceramic green sheet having no conductive pattern is also prepared in addition to the mother sheet having the conductive pattern.

Next, the mother sheets are stacked. Specifically, a predetermined number of mother sheets having no conductive pattern to provide the first outer layer portion X1 are stacked, a plurality of mother sheets having the conductive pattern to provide the inner layer portion C are successively stacked thereon, and a predetermined number of mother sheets having no conductive pattern to provide the second outer layer portion X2 are stacked so as to form a mother sheet group.

The mother sheet group is pressure-bonded. A mother multilayer body is formed due to the mother sheet group being pressurized and pressure-bonded in the stacking direction T by isostatic press or rigid body press.

The mother multilayer body is divided. Specifically, the mother multilayer body is divided in the matrix by push cutting or cutting with a dicing machine so as to be individualized into a plurality of unfired multilayer bodies.

The unfired multilayer body is subjected to barrel polishing. Specifically, the unfired multilayer body and a media ball having higher hardness than a ceramic material are sealed together in a small box called barrel, and a corner portion and a ridge portion of the unfired multilayer body are provided with roundness in the shape of a curved surface by the barrel being rotated.

The unfired multilayer body is fired. Specifically, the unfired multilayer body is heated to a predetermined temperature, and a dielectric ceramic material is thereby fired. The firing temperature is appropriately set in accordance with the type of the dielectric ceramic material and is set to be within the range of, for example, about 900° C. or higher and about 1, 300° C. or lower.

An underlying electrode layer is formed on the surface of the main body portion 110 that is a multilayer body. Specifically, the underlying electrode layer 121 of each of the first outer electrode 120A and the second outer electrode 120B is formed by various thin film formation methods, various printing methods, a dipping method, or the like. For example, when the underlying electrode layer is formed by the dipping method, after a conductive paste is applied to the first end surface 115 and the second end surface 116 of the main body portion 110, the conductive paste is baked. The conductive paste includes an organic solvent, a metal particle, and glass. The baking temperature is set to be within the range of, for example, about 700° C. or higher and about 900° C. or lower.

The Ni plating layer 122 and the upper plating layer 123 are successively formed by electrolytic plating so as to cover the underlying electrode layer 121 due to plating. Each of the above-described electrodes being formed defines the first outer electrode 120A and the second outer electrode 120B.

In the present example embodiment, the Ni plating layer 122 is formed by electrolytic plating by using a barrel electroplating device. The S compound ratio, the S atomic concentration, and the S compound concentration of the Ni plating layer 122 can be appropriately adjusted by controlling the processing condition, such as the type and the concentration of the component in the plating solution used for the above-described electrolytic plating, the current density of a current applied during electrolytic plating, the treatment temperature, or the strength of agitation of the plating solution.

In the present example embodiment, the plating solution includes Ni sulfamate. Ni sulfamate may be a hydrate (for example, Ni sulfamate·tetrahydrate). The plating solution may further include a halide ion, a carboxylic acid salt, boric acid, phosphoric acid, and the like. In addition, the plating solution may include additives, for example, organic materials including S, such as saccharin, benzenesulfonic acid, benzothiazole, thiourea, benzenesulfonic amide, naphthalenesulfonic acid, and allyl sulfonic acid.

The electronic component 100, that is a multilayer ceramic capacitor, according to the first example embodiment of the present invention is produced through a series of the above-described steps.

### Second Example Embodiment

In the electronic component according to a second example embodiment of the present invention, an outer electrode includes an underlying electrode layer, a resin electrode layer, a Ni plating layer, and an upper plating layer successively from the main body portion side. Regarding the electronic component according to the second example embodiment of the present invention, points different from the electronic component according to the first example embodiment of the present invention will be mainly described below.

FIG. 4 is a sectional view illustrating the electronic component according to the second example embodiment of the present invention. FIG. 4 illustrates the electronic component 200 when a cross section is viewed in the manner akin to that in FIG. 2. In the electronic component 200 according to the second example embodiment of the present invention, the outer electrode 120 includes an underlying electrode layer 121, a resin electrode layer 124, a Ni plating layer 122, and an upper plating layer 123 successively from the main body portion 110 side.

The resin electrode layer 124 is arranged so as to cover the underlying electrode layer 121. The resin electrode layer 124 can be arranged on the surface of the underlying electrode layer 121, the surface corresponding to the first end surface 115 and the second end surface 116.

In FIG. 4, the resin electrode layer 124 is arranged on the surface of the underlying electrode layer 121 arranged on the first end surface 115 and the surface of the underlying electrode layer 121 arranged on the second end surface 116.

For example, the resin electrode layer 124 may be arranged on the surface of the underlying electrode layer 121, the surface corresponding to the first end surface 115 and the second end surface 116, so as to be extended to the surface of the underlying electrode layer 121, the surface corresponding to the first principal surface 111, the second principal surface 112, the first side surface 113, and the second side surface 114.

In this regard, the resin electrode layer 124 may be arranged on only the surface of the underlying electrode layer 121 arranged on the first end surface 115 or may be arranged so as to cover the surface of the underlying electrode layer 121 arranged on the first end surface 115 and a portion of the surface of the underlying electrode layer 121 arranged on the first principal surface 111, the second principal surface 112, the first side surface 113, and the second side surface 114.

The thickness of the resin electrode layer 124 is, for example, about 10 μm or more and about 200 μm or less.

The resin electrode layer 124 includes a thermosetting resin and, therefore, has rich flexibility compared with, for example, the plating layer and the underlying electrode layer 121. Consequently, even when a shock derived from a physical shock or a thermal cycle is applied to the electronic component 200, the resin electrode layer 124 functions as a buffer layer, and a crack can be reduced or prevented from occurring in the electronic component 200.

Regarding the thermoplastic resin included in the resin electrode layer 124, known various thermoplastic resins can be used. The thermosetting resin may include at least one of epoxy resins, phenol resins, urethane resins, silicone resins, or polyimide resins.

Regarding the metal particle included in the resin electrode layer 124, a Ag powder, a Cu powder, or an alloy powder thereof can be used. In addition, a metal powder in which the surface of the metal particle is coated with Ag can be used.

The resin electrode layer 124 can be formed by applying a resin electrode conductive paste so as to cover the underlying electrode layer 121 and, thereafter, heat-treating the resin electrode conductive paste at a temperature of, for example, about 80° C. or higher and about 280° C. or lower so as to thermally cure the thermosetting resin. Regarding the resin electrode conductive paste, the resin electrode conductive paste is heat-treated at a temperature of preferably about 180° C. or higher and about 230° C. or lower, for example.

### EXAMPLES

Example embodiments of the present invention will be described below in more detail with reference to Examples. In Example, “%” and “part” are % by mass and portions by mass, unless otherwise specified.

### S Compound Ratio and S Atomic Ratio

Regarding the state of S present in the Ni plating layer, SK absorption edge measurement by using XAFS at BL6N1 of AichiSR was performed by a fluorescence yield method, a ratio of the atomic state to the compound state was calculated by using analysis software Athena, and the S compound ratio and the S atomic ratio were determined.

### Measurement of S Atomic Concentration and S Compound Concentration

Weight concentrations of S included in the compound state and the atomic state relative to a total weight of Ni and S included in the Ni plating layer were quantitatively evaluated by a wavelength-dispersive X-ray fluorescence spectroscopy (“ZSX Primus IV” produced by Rigaku Corporation), and the S atomic concentration and the S compound concentration were calculated from the S atomic ratio and the S compound ratio determined as described above.

### Ni Metal Ratio

Before the upper plating layer was formed in Examples and Comparative examples, regarding the surface of the Ni plating layer, the ratio of the amount of unoxidized Ni to the amount of all Ni (metal state ratio) was calculated from a Ni2p spectrum measured using X-ray photoelectron spectroscopy (VersaProbe produced by ULVAC-PHI, Inc.). According to the above-described X-ray photoelectron spectroscopy, the Ni metal state ratio from the surface of the Ni plating layer to a depth of about 5 nm is determined.

### Measurement of Film Stress

The plating film stress of the Ni plating layer was measured using an X-ray diffractometer (D8 DISCOVER produced by BRUKER) by the Ψ2 method in which a Ni (113) plane was used. The internal stress applied to the Ni plating layer in the tensile direction is indicated by a positive (+) numerical value, and the internal stress applied in the contraction direction is indicated by a negative (−) numerical value.

### Preparation of Plating Solution

Plating solutions 1 to 3 including a predetermined concentration of the respective components presented in Table 1 were prepared.

TABLE 1

| | Component | Concentration | |
|---|---|---|---|
| Plating solution 1 | Ni sulfate•hexahydrate | 280 | g/L |
| Plating solution 2 | Ni sulfate•hexahydrate | 280 | g/L |
| | saccharin sodium•dihydrate | 1 | g/L |
| Plating solution 3 | Ni sulfamate•tetrahydrate | 280 | g/L |

### Example 1

An electronic component having a configuration of the electronic component 100 according to the first example embodiment was produced. The Ni plating layer 122 was formed under the electrolytic plating condition presented in Table 2. Regarding the produced electronic component, the thickness of the outer electrode 120 was 30 μm, the thickness of the Ni plating layer 122 was 4 μm, the thickness of the upper plating layer 123 was 4 μm, the dimension in the length direction L was 1.10 mm, the dimension in the width direction W was 0.600 mm, the dimension in the stacking direction T was 0.600 mm, the thickness of each of the plurality of dielectric layers 130 included in the inner layer portion C was 0.60 μm, the thickness of each of the plurality of inner electrode layers 140 included in the inner layer portion C was 0.50 μm, the dimension in the length direction L of each of the first end margin portion E1 and the second end margin portion E2 was 40 μm, the dimension in the width direction W of each of the first side margin portion S1 and the second side margin portion S2 was 20 μm, and the dimension in the stacking direction T of each of the first outer layer portion X1 and the second outer layer portion X2 was 30 μm. The results are presented in Table 2.

### Examples 2 to 5 and Comparative Examples 1 to 11

Electronic components were produced in the manner akin to that of Example 1 except that the electrolytic plating condition in Example 1 was changed to the electrolytic plating condition presented in Table 2. The results are presented in Table 2.

TABLE 2

| | Electrolytic | | | | | | |
|---|---|---|---|---|---|---|---|
| | plating condition | | S | S concentration | | | Ni |
| | Type of | Current | compound | Atomic | Compound | Film | metal |
| | plating | density | ratio | state | state | stress | ratio |
| | solution | (A/dm²) | (%) | (ppm) | (ppm) | (MPa) | (%) |
| Comparative | Plating | 0.1 | 100 | 0 | 21 | 140 | 31 |
| example 1 | solution 1 | | | | | | |
| Comparative | Plating | 1 | 100 | 0 | 31 | 87 | 35 |
| example 2 | solution 1 | | | | | | |
| Comparative | Plating | 10 | 100 | 0 | 63 | 108 | 31 |
| example 3 | solution 1 | | | | | | |
| Comparative | Plating | 0.1 | 6 | 233 | 14 | −54 | 9 |
| example 4 | solution 2 | | | | | | |
| Comparative | Plating | 0.4 | 10 | 242 | 27 | −34 | 7 |
| example 5 | solution 2 | | | | | | |
| Comparative | Plating | 1 | 2 | 360 | 8 | −92 | 4 |
| example 6 | solution 2 | | | | | | |
| Comparative | Plating | 4 | 9 | 277 | 40 | −49 | 9 |
| example 7 | solution 2 | | | | | | |
| Comparative | Plating | 10 | 13 | 230 | 60 | −44 | 8 |
| example 8 | solution 2 | | | | | | |
| Comparative | Plating | 0.1 | 20 | 142 | 35 | −28 | 2 |
| example 9 | solution 3 | | | | | | |
| Comparative | Plating | 20 | 100 | 0 | 45 | 78 | 29 |
| example 10 | solution 3 | | | | | | |
| Comparative | Plating | 30 | 100 | 0 | 108 | 92 | 31 |
| example 11 | solution 3 | | | | | | |
| Example 1 | Plating | 1 | 50 | 108 | 109 | −23 | 26 |
| | solution 3 | | | | | | |
| Example 2 | Plating | 4 | 83 | 8 | 40 | 32 | 26 |
| | solution 3 | | | | | | |
| Example 3 | Plating | 10 | 91 | 3 | 30 | 12 | 27 |
| | solution 3 | | | | | | |
| Example 4 | Plating | 0.4 | 45 | 72 | 60 | −12 | 30 |
| | solution 3 | | | | | | |
| Example 5 | Plating | 0.2 | 25 | 163 | 53 | −73 | 25 |
| | solution 3 | | | | | | |

As presented in Table 2, in Examples 1 to 5 in accordance with example embodiments of the present invention, the film stress of the Ni plating layer was low, and the Ni metal ratio was high, whereas in Comparative example 1 to 3, 10, and 11 in which the S compound ratio was 100%, the film stress of the Ni plating layer was high, and in Comparative examples 4 to 9 in which the S compound ratio was less than 25%, the Ni metal ratio was low. Regarding the ceramic electronic component according to the present invention, it is clear that oxidation and internal stress of the Ni plating layer are reduced or prevented by formation of one Ni plating layer.

In the above-described explanations of the example embodiments, combinable configurations may be combined with each other.

It should be understood that the example embodiments disclosed above are exemplifications in all points and are not limitative. The scope of the present invention is not limited by the above-described explanations but is determined by the claims, and it is intended that the claims cover equivalents of the claims and also cover various additional example embodiments, modifications, or combinations, within the scope of the claims.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A ceramic electronic component comprising:
a main body; and
an outer electrode on a surface of the main body; wherein
the outer electrode includes a nickel plating layer;
the nickel plating layer includes sulfur in a compound state and an atomic state; and
a ratio of an amount of sulfur included in the compound state to all sulfur included in the compound state and the atomic state in the nickel plating layer is about 25% or more and less than about 100%.

2. The ceramic electronic component according to claim 1, wherein a weight concentration of sulfur included in the atomic state relative to a total weight of nickel and sulfur included in the nickel plating layer is about 3 ppm or more and about 163 ppm or less.

3. The ceramic electronic component according to claim 1, wherein a weight concentration of sulfur included in the compound state relative to a total weight of nickel and sulfur included in the nickel plating layer is about 30 ppm or more and about 109 ppm or less.

4. The ceramic electronic component according to claim 1, wherein the outer electrode includes an underlying electrode layer, the nickel plating layer, and an upper plating layer successively from a main body side.

5. The ceramic electronic component according to claim 1, wherein the outer electrode includes an underlying electrode layer, a resin electrode layer, the nickel plating layer, and an upper plating layer successively from a main body side.

6. The ceramic electronic component according to claim 1, wherein the ceramic electronic component is a multilayer ceramic capacitor.

7. The ceramic electronic component according to claim 1, wherein the ceramic electronic component is a multilayer thermistor, a multilayer inductor, or a ceramic battery.

8. The ceramic electronic component according to claim 1, wherein the main body includes an end margin portion with a dimension of about 10 μm or more and about 30 μm or less in a length direction of the ceramic electronic component.

9. The ceramic electronic component according to claim 1, wherein the main body includes dielectric layers each having a thickness of about 0.4 μm or more and about 0.8 μm or less.

10. The ceramic electronic component according to claim 1, wherein the ceramic electronic component has a dimension in a length direction of about 2.0 mm or less, a dimension in a width direction of about 1.25 mm or less, and a dimension in a stacking direction of about 1.25 mm or less.

11. The ceramic electronic component according to claim 1, wherein the main body includes inner electrode layers each having a thickness of about 0.3 μm or more and about 1.0 μm or less.

12. The ceramic electronic component according to claim 4, wherein the underlying electrode layer is a baked layer and includes metal and glass or a metal oxide.

13. The ceramic electronic component according to claim 4, wherein the underlying electrode layer includes a plurality of stacked layers.

14. The ceramic electronic component according to claim 1, wherein the nickel plating layer includes substantially only nickel.

15. The ceramic electronic component according to claim 1, wherein the nickel plating layer includes only one layer.

16. The ceramic electronic component according to claim 1, wherein the sulfur in the compound state is nickel sulfamate or nickel sulfate.

17. The ceramic electronic component according to claim 1, wherein a ratio of an amount of nickel in a metal state in a surface of the nickel plating layer to all nickel in the surface of the nickel plating layer is about 10% or more, about 15% or more, about 20% or more, or about 25% or more.

18. The ceramic electronic component according to claim 1, wherein a film stress of the nickel plating layer is about 50 MPa or less, about 40 MPa or less, or about 35 MPa or less.

19. The ceramic electronic component according to claim 1, wherein the nickel plating layer has an average thickness of about 0.5 μm or more and about 10 μm or less, about 5.5 μm or less, or about 4.5 μm or less.

20. The ceramic electronic component according to claim 4, wherein the upper plating layer includes tin and has a thickness of about 0.5 μm or more and about 10 μm or less, or about 4.5 μm or less.
